(19) United States
(12) Patent Application Publication
(10) Pub. No.: US 2026/0079670 A1
(43) Pub. Date: Mar. 19, 2026

(54) NETWORKED AUDIO-RELATED DIGITAL SIGNAL PROCESSING

(71) Applicant: Shure Acquisition Holdings, Inc., Niles, IL (US)

(72) Inventors: Matthew R. Kirsch, Evanston, IL (US); Bijal Joshi, Schaumburg, IL (US); Jonathan Portwood, Vernon Hills, IL (US); Lars Michael Petersen, Copenhagen (DK); Hui Jing, Copenhagen (DK); Martin Andersen, Copenhagen (DK)

(21) Appl. No.: 19/266,784

(22) Filed: Jul. 11, 2025

Related U.S. Application Data
(60) Provisional application No. 63/694,477, filed on Sep. 13, 2024.

(51) Int. Cl. G06F 3/16

(52) U.S. Cl. CPC G06F 3/165

(57) ABSTRACT

Digital signal processing (DSP) may be distributed across a plurality of endpoints and one or more aggregators in an audio system. An aggregator may perform DSP and/or may control DSP features performed by endpoints based on DSP feature capability of the endpoints and the aggregator. Links may be established between the aggregator and the endpoints to communicate audio signals and related information for performing the DSP features.

### CROSS-REFERENCE TO RELATED APPLICATIONS

This application claims the benefit of U.S. Provisional Patent Application No. 63/694,477 titled “Networked Audio-Related Digital Signal Processing” filed on Sep. 13, 2024, which is incorporated by reference in its entirety herein.

### TECHNICAL FIELD

Aspects of the disclosure relate to electronic audio communications and more specifically to audio digital signal processing in a network.

### BACKGROUND

Digital signal processing (DSP) is used to improve audio signals. In an audio system, a centralized processor performs DSP on audio signals received from audio devices such as microphones. Audio received by each microphone is communicated to the centralized processor. DSP by the centralized processor is subject to limitations of the centralized processor, such as processing speed, bandwidth, capacity, temperature constraints, and the like.

### SUMMARY

The following presents a simplified summary of the disclosure in order to provide a basic understanding of some aspects of the disclosure. This summary is not an extensive overview of the disclosure. It is not intended to identify key or critical elements of the invention or to delineate the scope of the invention. The following summary merely presents some concepts of the disclosure in a simplified form as a prelude to the more detailed description provided below.

An audio system is described herein that may comprise an aggregator and a plurality of endpoints for communicating and/or processing audio signals and related information. Endpoints may comprise any device capable of receiving, sending, and/or processing audio and related information, such as a microphone, speaker, video camera, sensor, and the like. At least some endpoint devices may be configured to operate as an aggregator device, such that an aggregator device may be capable of receiving, sending, and/or processing audio and related information. An aggregator may control DSP performed by the endpoints in a distributed/networked manner. For example, rather than a single device/component such as a centralized processor performing all DSP features for an audio system, DSP in the audio system described herein may be distributed across a plurality of devices/components. DSP features for endpoints may be enabled/disabled and/or activated/deactivated under control of an aggregator to facilitate efficient use of DSP capabilities across the audio system. The DSP features performed by endpoints may be in addition to or in place of at least some DSP features performed by an aggregator, for example, based on various system requirements, capabilities, bandwidth, and/or conditions. Different DSP features may be performed by different audio devices in a networked manner that may optimize DSP across the audio system.

The audio system described herein may provide a variety of advantages over other audio systems. For example, by distributing DSP features across devices, the audio system described herein may avoid overloading any single device, such as an aggregator device, by not overusing DSP capabilities (e.g., processing, bandwidth, memory, capacity, etc.) of that device and by instead sharing DSP across a plurality of devices (e.g., endpoint devices and/or other aggregator devices). Additionally or alternatively, by distributing DSP features across devices, groups of audio devices may be configured to perform certain DSP features in a complementary and networked manner, for example, based on endpoint device locations and/or capabilities. The audio system described herein may be flexible to accommodate a variety of configurations that may allow for ease of scalability, such as by accommodating the addition of endpoint devices without a corresponding need for additional aggregator devices to perform DSP. The audio system described herein may provide improved efficiency, for example, by enabling devices that may be better equipped, located, and/or capable of performing certain DSP to perform those DSP features. The audio system described herein may provide improved robustness and/or flexibility, for example, by not relying upon a single device for all DSP of the audio system. The audio system described herein may provide enhanced performance for DSP and/or other operations, for example, by using devices with sufficient bandwidth, capacity, and/or capability to perform DSP in place of exclusive reliance on an aggregator that may have more limited bandwidth, capacity, and/or capability to perform all DSP required for the audio system. These are non-limiting examples of advantages of the audio system described herein, and other advantages will be apparent based on descriptions herein.

These features, along with many others, are described in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example audio system for networked DSP;

FIG. 2 shows an example audio system using feature groups for networked DSP;

FIG. 3 shows an example computing device for performing networked DSP;

FIG. 4A shows an example method to configure an audio system;

FIG. 4B shows an example method to configure an audio system;

FIG. 5 shows an example method for configuring networked DSP features; and

FIG. 6 shows an example method for configuring networked DSP features.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. It is noted that various connections between elements are discussed in the following description. It is noted that these connections are general and, unless specified otherwise, may be direct or indirect, wired or wireless, and that the specification is not intended to be limiting in this respect.

As described in more detail herein, an audio system may be provided that comprises an aggregator and a plurality of endpoints. DSP features related to audio may be performed by the aggregator and/or by the endpoints in a distributed/networked manner that may be controlled by the aggregator. For example, rather than a single device/component performing all DSP features for an audio system (e.g., in a room, hall, building, group of buildings or campus, indoor or outdoor venue, etc.), DSP in the audio system described herein may be distributed across a plurality of devices/components such as endpoints (e.g., in addition to or in place of DSP by an aggregator) based on various system requirements, capabilities, bandwidth, and/or conditions.

DSP may comprise any digital signal processing of an audio signal and/or of information relating to an audio signal. For example, analog audio signals may be converted into digital audio signals, and one or more processors may perform DSP on the digital audio signals. Additionally or alternatively, DSP relating to the audio signals may be performed, such as to determine a source, location, and/or any other information relating to an audio signal. DSP may comprise one or more operations corresponding to audio-related features such as mixing, filtering, equalization, noise reduction, acoustic echo cancellation, automatic gain control, delay, compression, surround sound features, using audio to control other operations such as non-audio operations (e.g., using audio to direct a camera at an audio source, to activate a camera and/or a recording function in a room where audio is detected, and/or to perform some other activity associated with audio), and the like. These are non-exhaustive examples of DSP features, and generally, any other type of DSP features may be used in the disclosed audio system that may improve the perceived sound quality of one or more audio signals.

DSP may be distributed across an aggregator device and one or more endpoint devices. For example, an endpoint device may detect audio using a first DSP feature (e.g., activity-based operation associated with audio). The endpoint device may communicate with an aggregator device to inform the aggregator device about the audio detection. Based on the communication of the audio detection, the aggregator device may perform a second DSP feature (e.g., mixing, filtering, equalization, noise reduction, noise cancellation, etc.) on the detected audio. For example, if the detected audio is a noise source, the noise may be detected by a first component (e.g., an endpoint device) using a first DSP feature, and the noise may be canceled and/or reduced by a second component (e.g., an aggregator device) using a second DSP feature. Additionally or alternatively, the second component may receive other information from other components (e.g., other endpoint devices) that may perform one or more additional DSP features (e.g., specific location identification of an audio source that may be a noise source) or the first DSP feature (e.g., noise detection), and the second component may corroborate the noise detection by the first component by using the other information from the other components and/or further refine the detected audio (e.g., using the second DSP feature and/or one or more other DSP features). For example, based on the initial information of the detected audio, and based on the additional information received from the other components, the second component (e.g., an aggregator device) may perform one or more DSP features on the audio to provide an output audio signal with an overall improved perceived quality relative to audio received by the other components (e.g., by endpoint devices) and/or to control one or more devices to perform a function (e.g., exclude and/or reduce a level of a noise source in a mix, steer an array microphone beam away from the direction of a noise source, etc.) that may improve the overall perceived audio quality. These are non-limiting examples of DSP coordination, and any other distributed DSP may be performed across components/devices in the audio system described herein. The audio system is described in further detail with respect to the following figures.

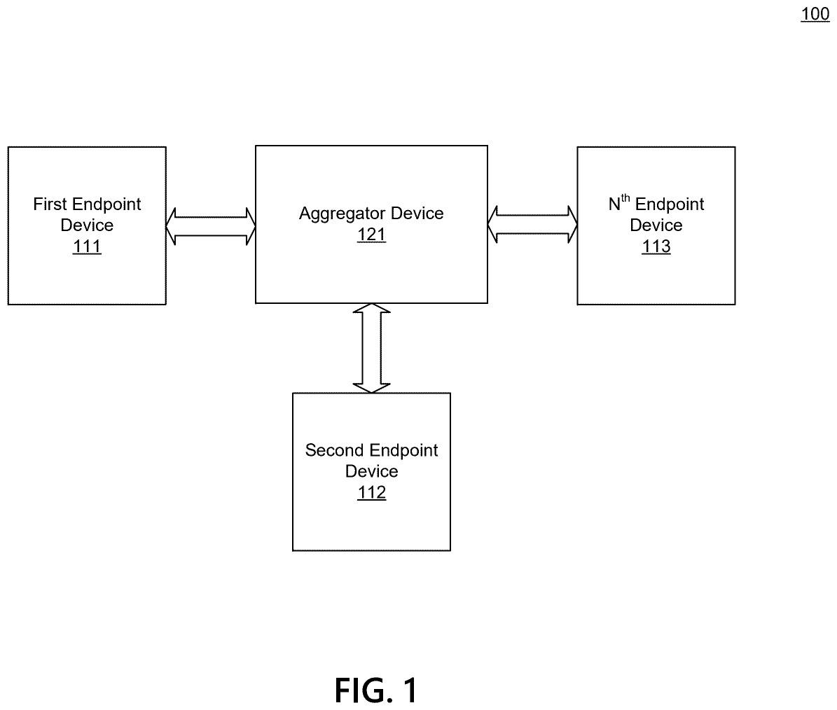

FIG. 1 shows an audio system 100. The audio system 100 may be configured for networked DSP. The audio system 100 may comprise at least one aggregator device 121 and a plurality of endpoint devices 111-113. The audio system may comprise any combination of audio devices for networked communication within an environment (e.g., in a room, hall, building, group of buildings or campus, indoor or outdoor venue, etc.). The plurality of endpoint devices may comprise any quantity of endpoint devices, such as a first endpoint device 111, a second endpoint device 112, and up to an Nth endpoint device 113, where N may be any positive integer. In at least some examples, the aggregator device 121 may comprise a different device as the endpoint devices 111-113. In at least some other examples, the aggregator device 121 may itself be an endpoint device, such that an endpoint device may operate as the aggregator device 121 by performing an aggregating function. In still other examples, one or more endpoints may correspond to logical operations on a single computing device, and/or one or more endpoints may be combined with an aggregator in a single computing device. Thus, the aggregator device 121 and the plurality of endpoint devices 111-113 shown in FIG. 1 may correspond to separate physical computing devices, or one or more of such devices may be combined (such as being logical operations, software implementations, and/or hardware elements) within a single computing device.

The aggregator device 121 may operate to control at least some operation of the plurality of endpoint devices 111-113. For example, the aggregator device 121 may communicate with one or more of the plurality of endpoint devices 111-113 (e.g., one, some, or all of the endpoint devices). The aggregator device 121 may communicate with the endpoint device(s) 111-113 via one or more communication channels, such as via a non-time-critical protocol (e.g., ACN). The aggregator device 121 may be configured to receive data from the endpoint device(s) 111-113. Additionally or alternatively, the aggregator device 121 may be configured to send data to the endpoint device(s) 111-113. One or more connections, links, channels, and/or time-critical data protocols (e.g., Dante, AES67, RTP, etc.) may be used to communicatively connect the endpoint devices 111-113 (e.g., via the aggregator 121). For example, one or more subscriptions may be made on the aggregator device 121 for channel(s) receiving data from the endpoint device(s) 111-113. One or more subscriptions may be made on endpoint device(s) (e.g., 111-113) for sending data to another endpoint device (e.g., another of 111-113). One or more communication channels (e.g., Dante channel(s) and the like) may be allocated as fixed channels. In at least some examples, the aggregator device 121 may be configured with a plurality of input channels to communicate with a corresponding plurality of endpoint devices. For example, the aggregator device 121 may be configured with three input channels to communicate with three endpoint devices 111, 112, and 113 (e.g., where N in FIG. 1 may be three, although N may be any other positive integer). The aggregator device 121 may be configured with any other quantity of input channels. The aggregator device 121 may be configured with at least one output channel. In at least some examples, the aggregator device 121 may be configured with one output channel that may be used to communicate with each of a plurality of endpoint devices (e.g., 111-113). In other examples, the aggregator device 121 may be configured with a plurality of output channels that may be used to communicate with a plurality of endpoint devices (e.g., 111-113). A quantity of output channels may be different from (or the same as) a quantity of endpoint devices with which the aggregator device 121 may be configured to communicate.

The plurality of endpoint devices 111-113 may be configured (e.g., pre-configured and/or configured by one or more aggregator devices) to work together as audio processing devices to perform one or more audio-related DSP features in a networked manner. For example, at least some of the plurality of endpoint devices 111-113 (and/or the aggregator device 121) may be configured to perform one or more operation(s) such as: discover feature availability, determine feature and/or device compatibility, control feature and/or device behavior (e.g., on a local and/or remote device), configure real-time data exchange with one or more other devices in the system, dynamically update devices in the system (e.g., add, remove, configure, etc.), and/or monitor the status of devices in the system. A feature may correspond to an audio processing feature, such as audio transmission/reception (e.g., single microphone, array microphone, multi-array, etc.), mixer (e.g., a networked auto-mixer), noise reducer (e.g., networked noise reduction), any audio feature referenced herein, and/or any other audio feature. Additionally or alternatively, a feature may correspond to a feature associated with audio, such as audio source detection, audio source location, statistics derived from one or more audio signals (e.g., time-averaged audio signal level in specific frequency band(s)) and/or operation relating to audio (e.g., controlling positioning and/or other operation of a video camera configured to receive images/video and audio). The audio system 100 may operate by the aggregator device 121 communicating (e.g., wired and/or wirelessly) with the plurality of endpoint devices 111-113 to configure one or more endpoint devices (e.g., first endpoint device 111 and second endpoint device 112) to each perform at least a portion of DSP for at least one feature, whereby collective DSP for the feature(s) is divided among the two or more devices (e.g., two endpoint devices, one aggregator device and one endpoint device, etc.). By performing such networked DSP, the system 100 may provide various advantages, such as but not limited to improved efficiency, enhanced performance, and/or increased reliability, as described further herein.

After initial configuration and subscribing to the data, the aggregator device 121 may be able to reestablish (e.g., automatically reestablish) a connection with an endpoint device (e.g., 111-113), for example, after the endpoint device reboots and returns to being online. In at least some examples, endpoint device(s) (e.g., 111-113) may have a subscription to the aggregator device 121 (e.g., for receiving data) such that the endpoint device(s) may retain information about the aggregator device 121 (e.g., channel name, device name, etc.). Various configurations may be implemented in the system 100, for example, in order to accommodate one or more additional channels being added to a channel list while maintaining a fixed usage of channels. In at least some configurations, the system 100 may be configured to accommodate one or more devices (e.g., endpoint devices 111-113, aggregator device 121, etc.) being rebooted, removed (e.g., by removing power), and/or reconfigured (e.g., to part of another feature group).

One or more aggregator devices 121 may be configured to control DSP by the endpoint device(s) 111-113. Additionally or alternatively, at least some endpoint devices (e.g., 111-113) may be configured to operate as an aggregator device in the system 100. For example, the Nth endpoint device 113 may operate as both an aggregator device and an endpoint device. The endpoint devices 111-113 may operate as a transmitting device (e.g., microphone), a receiving device (e.g., loudspeaker), and/or as a transceiver device (e.g., a microphone having a transceiver, a speaker/loudspeaker having a transceiver, etc.). Each computing device in the system 100 may be configured for one or more roles (e.g., specific role(s)). At least some endpoint devices 111-113 may be able to be configured to support different roles (e.g., microphone, relay device, audio processing device, etc.). Computing devices in the system 100 (e.g., 111-113, 121) may be made aware of their role in the system 100, and/or of other computing devices'roles in the system 100, for one or more networked features (e.g., a specific network feature). For at least some features, a computing device in the system 100 may take on multiple roles and/or may perform multiple features.

The system 100 may comprise two or more computing devices that support networked DSP features related to audio. For example, each endpoint device of the plurality of endpoint devices 111-113 may comprise one or more of: audio processing device(s), microphone(s), aggregator(s), mixer(s), noise reducer(s), speaker(s), and/or DSP device(s). Networked DSP features may comprise DSP processing on multiple devices that may be located in the same room, hall, building, group of buildings or campus, indoor or outdoor venue, etc. and that may operate together as a single system (e.g., system 100). Additionally or alternatively, networked DSP features may comprise DSP on multiple devices that may be located in different rooms (and/or different geographic areas) while still operating together as a single system. For example, the first endpoint device 111 may be located in the same room (and/or same general area) as the second endpoint device 112. Alternatively, the first endpoint device 111 may be located in a first room (and/or first geographic area) while the second endpoint device 112 may be located in a second room (and/or second geographic area) different from the first room/area. The networked DSP features may be performed by multiple devices (e.g., 111-113) communicatively connected (e.g., wired or wirelessly) on the same network (e.g., as system 100). The networked DSP features may be controlled (at least in part) by at least one aggregator (e.g., 121).

The endpoint devices 111-113 and/or the aggregator 121 may communicate via one or more channels, ports, protocols, and/or signals. For example, the endpoint devices 111-113 and/or the aggregator 121 may exchange feature configuration information via a first channel/port/protocol/signal, such as via non-time-critical protocol (e.g., Architecture for Control Networks (ACN) protocol). The endpoint devices 111-113 and/or the aggregator 121 may exchange time-critical information via a second channel/port/protocol/signal, such as via a time-critical protocol (e.g., Dante, AES67, real-time transport protocol (RTP)), which may be used for real-time audio DSP. At least some features (e.g., each feature) may have dedicated real-time data links (e.g., a collection of dedicated channels for a specific feature). Additionally or alternatively, a group (e.g., “pool”) of available channel(s) may be identified to the endpoint devices 111-113 and/or to the aggregator 121, and an endpoint and/or an aggregator may be configured to send data from multiple features over the available channel(s) (e.g., multiplexed communications). In at least some examples, each DSP feature may have its own corresponding/dedicated link. In at least some other examples, a feature may share one or more links with one or more other features, whereby communications for a feature may be multiplexed with communications for another feature on a same link. For example, communications may comprise packet communication in which a packet may comprise a plurality of fields, wherein each field of at least some of the plurality of fields may correspond to a dedicated field, within the packet, for a particular feature. A link for communication between devices (e.g., between first endpoint device 111 and aggregator 121, between second endpoint device 112 and aggregator 121, and/or between either of first/second endpoint devices 111/112 and Nth endpoint device 113 via aggregator 121, etc.) may comprise both transmit channel(s) from the aggregator device (e.g., 121) to the endpoint device(s) (e.g., 111, 112, 113) and/or transmit channel(s) from the endpoint device(s) (e.g., 111, 112, 113) to the aggregator device (e.g., 121).

Each endpoint device of the plurality of endpoint devices 111-113 may be configured to perform DSP for at least one feature. An advertisement operation may comprise communicating with a plurality of computing devices (e.g., endpoint devices, aggregator(s)) to indicate one or more roles and/or features for which a particular computing device is configured to perform. An endpoint and/or an aggregator device may communicate to other computing devices in the system 100 (e.g., endpoint devices, aggregator(s)) its feature version compatibility handling, such as for determining whether the particular computing device may perform DSP for one or more features. An endpoint and/or an aggregator may communicate with other computing devices in the system 100 (e.g., endpoint devices, aggregator(s)) to enable and/or disable control of a computing device, and/or to activate and/or deactivate a computing device, such as for performing DSP for one or more features. Feature activation and/or deactivation may enable real-time data associated with the feature to be produced and/or consumed by computing device(s) in the system 100. Computing devices (e.g., endpoint device(s), aggregator(s)) participating in a feature may be dynamically updated (e.g., added and/or removed). Such dynamic updating may be performed without removing one or more communication links between the computing device(s) (e.g., without tearing down a system). A real-time data link setup (e.g., via Dante, AES67, RTP, and/or any other time-critical channel) may be established between the endpoints 111-113 and aggregator(s) 121. Monitoring may be performed in which a status of computing devices (e.g., endpoint devices, aggregator(s), etc.) in the system 100 may be monitored. Error handling may be performed such as by re-routing and/or reallocating DSP features across computing devices, for example, if one or more computing devices is determined to no longer be available (e.g., powered off, disconnected from the network, unresponsive).

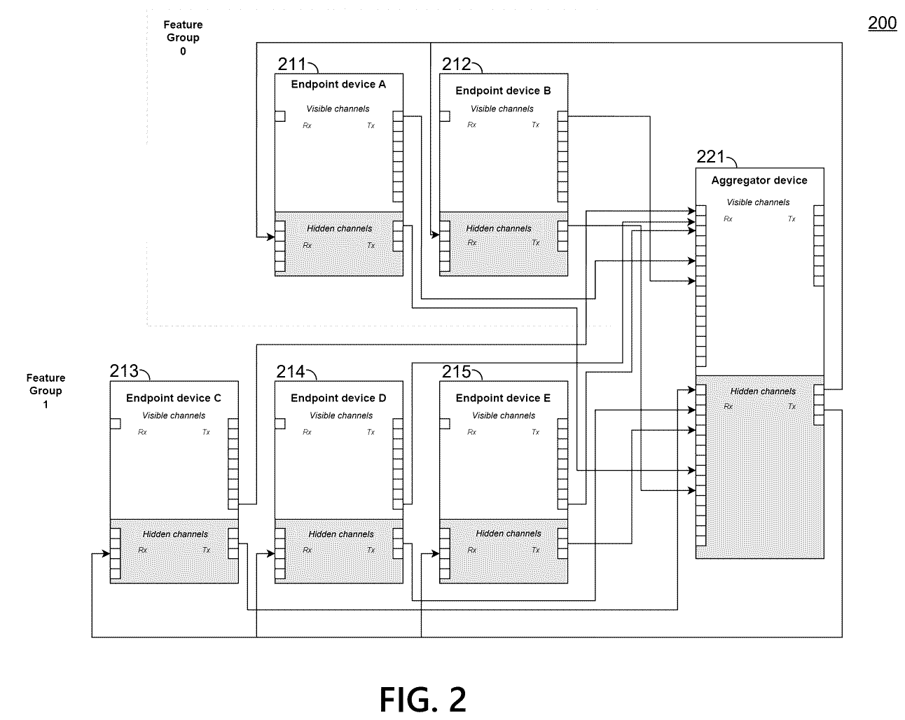

FIG. 2 shows an audio system 200. The audio system 200 may use feature groups for networked DSP. The audio system 200 may correspond to the audio system 100 described with respect to FIG. 1, descriptions of which are incorporated by reference here. The audio system 200 may comprise a plurality of endpoint devices 211-215 and at least one aggregator device 221. The endpoint devices 211-215 may correspond to the endpoint devices 111-113 described with respect to FIG. 1 and/or the at least one aggregator device 221 may correspond to the aggregator device 121 described with respect to FIG. 1, descriptions of which are incorporated by reference here. At least some endpoint devices 211-215 may be grouped by feature. A feature group ID may refer to an index of a particular feature group (e.g., 0 to M-1, where M is a maximum number of groups supported by an aggregator device for a particular feature). A feature group may refer to a collection of devices working together on a specific feature. A feature group may use a plurality of aggregation links, which may generally correspond to any real-time data link (e.g., via Dante, AES67, RTP, and/or any other time-critical channel). Any quantity of groups may be used, for example, based on a quantity of DSP features for which endpoint devices may be configured. For example, a plurality of endpoint devices 211 and 212 (e.g., Endpoint device A and Endpoint device B) may be configured to perform DSP for an initial feature, and these endpoint devices may be grouped as Feature Group 0. A plurality of endpoint devices 213, 214, and 215 (e.g., Endpoint device C, Endpoint device D, and Endpoint device E) may be configured to perform DSP for another feature (e.g., different from a feature of Feature Group 0) and/or another (independent) instance of the same feature in the same or different room, and these endpoint devices may be grouped as Feature Group 1. While two feature groups are shown in FIG. 2 (e.g., Feature Group 0 and Feature Group 1), any number of feature groups may be used.

As another example, a feature group may refer to a group of devices in a particular location and/or area, such as in a room, hall, building, zone, etc. Each device within that location and/or area may perform one or more DSP features collectively as a feature group. In this manner, a plurality of devices may be configured (e.g., enabled, activated, disabled, deactivated, controlled, etc.) as a group. For example, all devices in a room may have DSP features turned on after audio is detected in the room and/or after a person is detected in the room, and/or all devices in the room may have DSP features turned off after no audio is detected in the room (e.g., after a time duration) and/or after no motion is detected in the room (e.g., after a time duration). As another example, at least some devices in a feature group may perform the same or complementary/related functions and/or the same or complementary/related DSP features that may be controlled (e.g., by an aggregator device) in a networked manner. For example, devices in a feature group may perform the same (or similar) DSP feature(s), wherein each device in the feature group may perform the same one or more DSP features but in possibly different/distinct ways, such that a device's performance of a DSP feature may be complementary to other device performance for that DSP feature within the feature group. For example, some devices may have microphones that may be used to detect a presence and/or location of an audio source in a room (e.g., a person speaking, or a source of a noise such as an air conditioner, siren, fan, etc.) and may have otherwise relatively limited capability (e.g., low sound quality), whereas other devices may have more robust microphones configured to receive/process/send audio of a higher perceived quality. Both types of microphones may operate to perform DSP as a single DSP feature group, for example, specific to an area in which they are located. But each type of device's DSP may perform in different/distinct ways within that DSP feature group (e.g., noise detection versus audio signal enhancement). As another example, audio may be used to direct a camera at an audio source whereby endpoint devices A and B (e.g., Feature Group 0) may be in an area of one camera and endpoint devices C, D, and E (e.g., Feature Group 1) may be in an area of a second camera. In such an example, Feature Group 0 may be used to direct the positioning of the first camera, and Feature Group 1 may be used to direct the positioning of the second camera. As a result, both feature groups may be performing the same feature/functionality, but independently of each other.

Endpoint devices may be grouped by multiple DSP features such that inclusion in a feature group may correspond to being configured for a certain plurality of DSP features. At least some DSP features may be included in a plurality of different groups of endpoint devices (e.g., each feature group need not be mutually exclusive as to the DSP features that are included in it relative to other feature groups). The at least one aggregator device 221 may be configured to control allocation/assignment of DSP features to be performed by each group (e.g., by Feature Group 0 and by Feature Group 1) on a per-group basis. Additionally or alternatively, the at least one aggregator 221 may be configured to control allocation/assignment of DSP features to be performed by each endpoint device (e.g., each of endpoint devices 211-215). By grouping one or more DSP features in a feature group, the system 200 may be able to more efficiency control the DSP feature(s) by simplifying communications and coordinating operation across a plurality of devices. For example, a feature group corresponding to a particular area (e.g., a first zone or area of a room) may be controlled and coordinated for DSP as a group (e.g., first feature group), whereas a feature group corresponding to another area (e.g., a second zone or area of a room) may be controlled and coordinated for DSP as a different group (e.g., second feature group).

One or more of the plurality of endpoint devices 211-215 may perform transmission (Tx) and/or reception (Rx) using one or more visible channels and/or using one or more hidden channels. Visible and hidden channels may both be real-time data links (e.g., via Dante, AES67, RTP, and/or any other time-critical channel). “Visible” channels may refer to user-facing channels. “Hidden” channels may refer to internal, non-user-facing channels. Additionally or alternatively, the at least one aggregator 221 may perform transmission (Tx) and/or reception (Rx) using one or more visible channels and/or using one or more hidden channels. While some endpoint devices (e.g., 211-215) and an aggregator (e.g., 221) are shown in FIG. 2 having a particular quantity of transmission and/or reception channels (e.g., 211 is shown with one visible Rx channel, nine visible Tx channels, 5 hidden Rx channels, and 3 hidden Tx channels), each endpoint device (e.g., 211-215) and/or each aggregator (e.g., 221) may communicate (e.g., transmit and/or receive) using any quantity of visible Tx channels, any quantity of visible Rx channels, any quantity of hidden Tx channels, and/or any quantity of hidden Rx channels. While FIG. 2 shows one aggregator (e.g., 221), the system 200 may comprise any quantity of aggregators. For example, the system 200 may comprise a secondary aggregator per each feature group, wherein the secondary aggregator may configure each endpoint device within a particular feature group. A primary aggregator may be included in the system 200 that may configure one or more secondary aggregators and/or one or more endpoint devices.

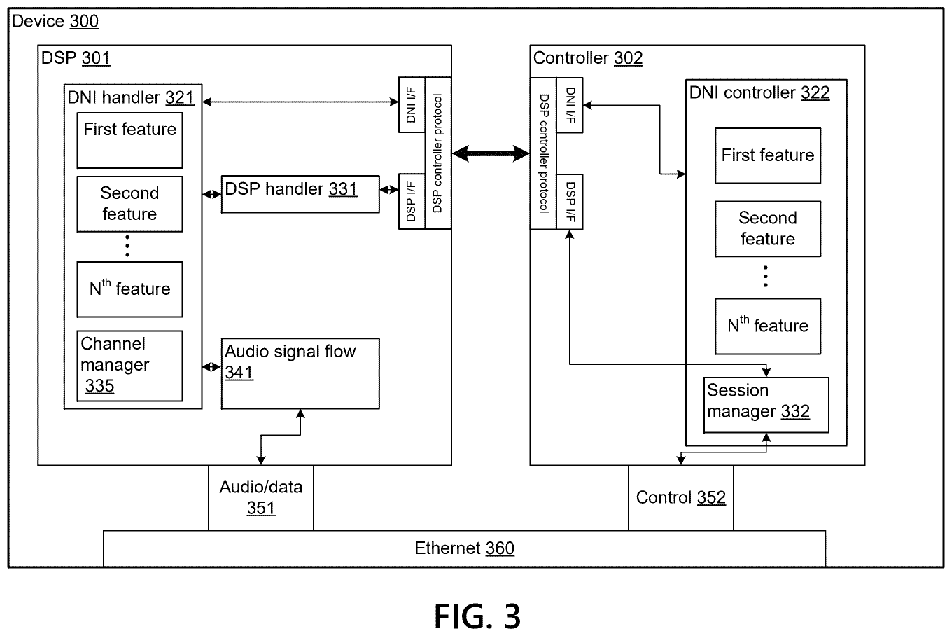

FIG. 3 shows a computing device 300. The computing device 300 may comprise any device configured to perform operations described herein, such as operations relating to networked DSP. For example, the computing device 300 may be an endpoint device, such as any of the endpoint devices described herein (e.g., 111-113, 211-215). Additionally or alternatively, the computing device 300 may be an aggregator, such as any of the aggregators described herein (e.g., 121, 221). The computing device 300 may comprise a DSP 301 and a controller 302. The DSP 301 may perform DSP features, including any of the audio processing and/or audio-related features described herein. “DSP” is used herein to refer to “digital signal processing” generally, and while such digital signal processing may be performed by one or more processors, DSP is used herein in its broadest sense to refer to digital signal processing generally. For example, the DSP 301 may comprise one or more digital signal processors or may comprise processing within one or more digital signal processors. The DSP 301 may comprise one or more of: a DSP networked infrastructure (DNI) handler 321, a DSP handler 331, a DNI interface (e.g., DNI I/F), a DSP interface (e.g., DSP I/F), a DSP controller protocol interface, and/or an audio signal flow 341. In at least some examples, the DNI handler 321 and the DSP handler 331 may be combined into a common element, component, and/or logic. The audio signal flow 341 may be configured to communicate audio signaling to/from the DNI handler 321 and an audio/data interface 351. The audio signal flow 341 may perform real-time data packing/unpacking for interfacing with the audio/data interface 351. The audio/data interface 351 may be used for communicating (e.g., sending/receiving) audio data and/or non-audio data (e.g., real-time non-audio data). The audio/data interface 351 may be coupled to an Ethernet interface 360 for communication with one or more other computing devices in an audio system (e.g., system 100, system 200, etc.). The DNI handler 321 may be configured to perform one or more DSP features, such as a first feature, second feature, and/or up to an N^{th} feature, where N is any integer greater than zero. DSP features may have corresponding feature controllers that control corresponding logic, that may be required for the particular feature, within the DSP handler 321. Feature logic may handle commands for setting up a feature, controlling the DNI handler 321 and DSP handler 331, and/or for setting up communication channels for the device 300. The DNI handler 321 may comprise a channel manager 335 that may manage channels for the audio signal flow 341.

The controller 302 may control operations for DSP features, including any of the audio processing and/or audio-related features described herein. The controller 302 may comprise one or more of: a DNI controller 322, a session manager 332 (e.g., as part of or separate from the DNI controller 322), a DNI interface (e.g., DNI I/F), a DSP interface (e.g., DSP I/F), and/or a DSP controller protocol interface. The DNI controller 322 may be responsible for enabling, monitoring, and/or disabling features across devices. The DNI controller 322 may start monitoring devices participating in a feature, for example, after that feature is enabled. The DNI controller 322 may monitor for any new device(s) that may be a candidate for the feature. The session manager 332 may monitor for device availability and the sessions to the device. The session manager 332 may perform real-time data link setup. The session manager 332 may report the status of the feature. Monitoring by the session manager 332 may differ depending on whether a device is an aggregator or an endpoint. For example, if the device is an aggregator device, the DNI controller 322 in the device may monitor all endpoint devices (e.g., all endpoint devices in communication with the aggregator device). In such a device, the DNI controller 322 may monitor status of feature(s) (e.g., to which the device is subscribed during enabling of the feature) to determine whether the feature(s) is/are still enabled and active. In such a device, the session manager 332 may monitor the device availability and the sessions to the device, and may report the status back to the DNI controller 322. If the device is an endpoint device, the DNI controller 322 may only monitor an aggregator device in communication with the endpoint device. In such a device, if the feature(s) that the device is participating in has been deactivated and disabled, an aggregation link may be torn down (e.g., in the DNI controller 322).

The DNI controller 322 may be inquired about the devices configured and/or available for participating in one or more feature groups for the one or more features, for example, if one or more features are configured in an aggregator device (e.g., 121, 221). If a list of available and/or compatible devices has been established, the DNI controller 322 may be enabled for the feature(s), and the feature(s) may be enabled in each endpoint device capable of performing such feature(s). The session manager 332 may notify the DSP 301 about all available device channel links. Thereafter, based on a real-time data link setup request from the DNI controller 322 for a particular feature, the DSP 301 may request the session manager 332 to setup the channels that may be required for the feature. The DNI controller 322 may be responsible for disabling one or more features in an aggregator device and/or in one or more endpoint devices.

The session manager 332 may be configured to control one or more sessions corresponding to one or more DSP features. The session(s) may be created dynamically. The session manager 332 may be configured to set up communication channels that may be required for a networked DSP feature. For example, channels may be requested by the DSP 301 after a feature has been enabled (e.g., after being enabled and receiving a real-time data link setup request from the DNI controller 322). The session manager 332 may be responsible for monitoring a connection (e.g., wireless connection and/or wired connection) and/or connected devices (e.g., wirelessly connected devices and/or wired connected devices). The session manager 332 may communicate (e.g., to the DNI handler 321 and/or to feature logic) if/when one or more connections are not working as expected and/or if/when a device goes offline. The session manager 332 may configure communications between the controller 302 and the DSP 301 via the DSP interface (e.g., DSP I/F) and/or the DSP controller protocol interface of the respective controller 302 and/or DSP 301. The session manager 332 may be configured to communicate via a control interface 352. The control interface 352 may be coupled to the Ethernet interface 360 for communication with one or more other computing devices in an audio system (e.g., system 100, system 200, etc.). The control interface may be configured for synchronous control information, such as via a real-time control interface (e.g., Dante, RTP, etc.), and/or for asynchronous control information, such as for a non-real-time control interface. The DNI controller 322 may be configured to perform one or more DSP features, such as a first feature, a second feature, and/or up to an Nth feature, as shown in FIG. 3, where N is any positive integer. DSP features may have corresponding feature controllers that control corresponding logic, required for the particular feature, within the DNI controller 322. The DNI controller 322 may be configured to start and/or control features across devices in an audio system (e.g., 100, 200). Feature logic may handle commands for setting up a feature, controlling the DNI controller 322, and/or for setting up communication channels for the device 300. While not shown, the controller 302 may be configured to communicate with an external controller interface (e.g., a third-party controller interface (TPCI)), which may provide for external control of the device 300.

The DNI controller 322 may be responsible for enabling, monitoring, and/or disabling features across devices (e.g., 300). For example, if a feature is configured in an aggregator device (e.g., 121, 221), the feature controller may inquire the DNI controller 322 about the devices configured and/or available for participating in a feature group. If a list of available and/or compatible devices has been established, the feature controller may enable the feature in a respective DNI controller (e.g., 322) in each endpoint device (e.g., 111-113, 211-215, 300). The DNI controller 322 may then notify the DSP 301 about channel links (e.g., about all available device channel links). As a result, each device (e.g., 300) may know/determine the role(s) of other device(s) for a feature and may be able to notify the DSP 301 that a given feature is enabled. The DSP 301 may then request the DSP handler 331 to setup the channel(s) required for the feature. The DNI controller 322 may similarly be responsible for disabling the feature in both the aggregator device and the endpoint device(s). The channel manager 335 may setup and/or manage the channel(s) required for the feature, for example, based on communication with the DSP handler 331.

The session manager 332 may be responsible for setting up the communication channels needed for one or more networked features. These channels may be requested by the DSP 301 after a feature has been enabled. The session manager 332 may be responsible for monitoring the connection and the devices connected. For example, if any connections are not working as expected and/or if a device goes offline, the DNI controller 322 and the features logic may be notified about the status of the connection.

A session may be created for each connection (e.g., for each channel connection) between an aggregator device and an endpoint device. Sessions may be reception (RX), transmission (TX), and/or bidirectional connections. For example, a session may be an RX connection from the perspective of an aggregator device and a TX connection from the perspective of an endpoint (e.g., an RX session may comprise data being transmitted from an endpoint and received by an aggregator); and/or a session may be a TX connection from the perspective of an aggregator device and an RX connection from the perspective of an endpoint (e.g., a TX session may comprise data being transmitted from an aggregator device and received at an endpoint device). An RX session may be a connection where an aggregator device is configured to receive data from an endpoint device. A TX session may be established when an aggregator device determines to send data to an endpoint device. In at least some examples, only RX sessions may be supported. In at least some other examples, TX sessions may be supported (e.g., in addition to RX sessions).

Sessions may be requested (e.g., by the DSP 301) by sending (e.g., to the controller 302) a request to create a session. After the session has been created, the controller 302 may send a response to the request. The response may comprise, for example, an identifier (ID) and/or status of the newly created session. A session may be maintained at least until the DSP 301 requests the session to be torn down (e.g., by sending a request to close the session) and/or at least until the device 300 reboots.

After a session is established, the controller 302 may monitor the session. The controller 302 may send an update (e.g., a session condition update) to the DSP 301, for example, if the condition of the session changes. An update may happen, for example, if an endpoint device reboots and/or if a real-time data link (e.g., a Dante subscription) is not working correctly. The controller 302 may continue monitoring and/or attempt to reestablish a session, for example, if the connection to an endpoint device is not working.

A device (e.g., 300) may cancel (e.g., automatically cancel) all existing subscriptions on the device, for example, if the device reboots. For example, if a device does not know whether a feature is still running, it may tear down all connections. It may be the up to an aggregator device (e.g., 121, 221) to reestablish the channels required for an active feature. If the aggregator device starts up, the feature may need to setup all RX and TX connections. If an endpoint device (e.g., 111-113, 211-215) starts up, the aggregator device, if still active, may reestablish any TX, RX, and/or bidirectional session to the endpoint device.

An audio system (e.g., 100, 200) may comprise a plurality of computing devices operating as one or both of an endpoint device (e.g., 111-113, 211-215) and an aggregator device (e.g., 121, 221), wherein the computing device may comprise one or more processors, memory storing instructions that may be executed by the one or more processors, and one or more of the DNI handler 321, the DSP handler 331, and/or the DNI controller 322. For example, the device 300 may be configured with additional or fewer features than shown in FIG. 3, and such a device may comprise one or more of the DNI handler 321 and/or the DNI controller 322 to perform any of the operations described herein with respect to one or more DSP features. In at least some examples, functionality described herein with respect to the DSP 301 may be performed by the controller 302, and/or functionality described herein with respect to the controller 302 may be performed by the DSP 301.

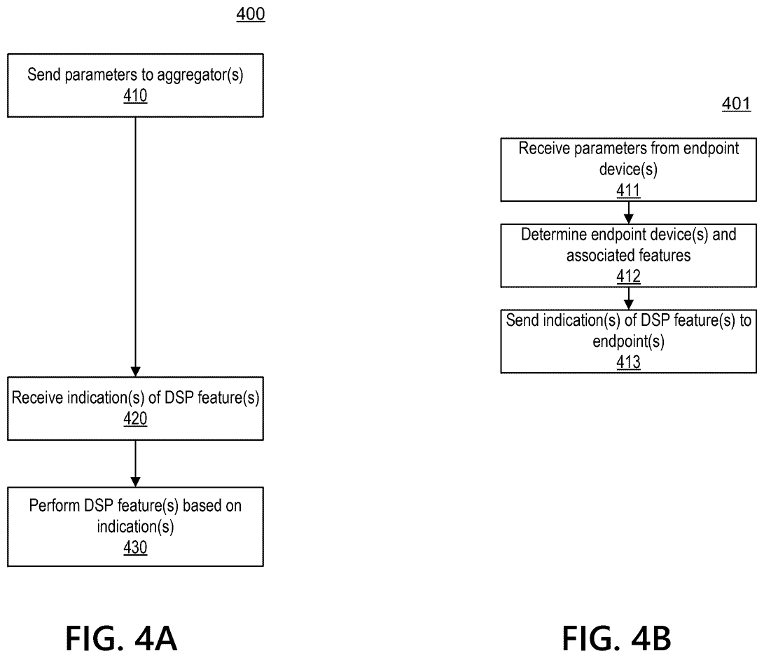

FIG. 4A and FIG. 4B show example methods to configure an audio system. The audio system may correspond to any audio system described herein (e.g., system 100, system 200). FIG. 4A shows an example method 400 that may be performed by one or more endpoint devices (e.g., 111-113, 211-215). FIG. 4B shows an example method 401 that may be performed by an aggregator device (e.g., 121, 221). Methods 400 and 401 may correspond to a combined method for configuring an audio system comprising a plurality of endpoint devices and at least one aggregator device. At step 410, one or more endpoint devices may send parameters to one or more aggregators. At step 411, an aggregator device may receive parameters from one or more endpoint devices. At step 412, the aggregator may determine endpoint device(s) and associated features for the respective endpoint device(s). The associated features may be features that the endpoint device may be configured and/or capable to perform. At step 413, the aggregator device may send one or more indication(s) of DSP feature(s) to the endpoint device(s). At step 420, one or more endpoint devices (e.g., the endpoint device(s) that previously sent the parameters at step 410) may receive indication(s) of DSP feature(s). At step 430, the one or more endpoint devices may perform the DSP feature(s) based on the indication(s). Step(s) shown and described with respect to FIG. 4A and/or FIG. 4B may be performed in any order and/or may be omitted.

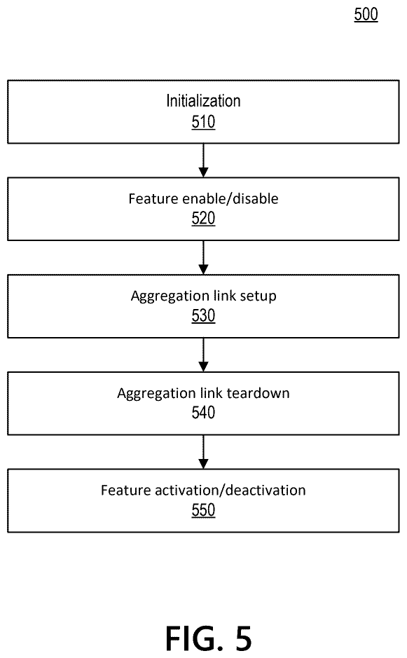

FIG. 5 shows an example method for configuring networked DSP features. A method 500 may be performed by one or more devices described herein (e.g., 111-113, 121, 211-215, 300). At step 510, a device may perform an initialization operation. The initialization operation may be performed by an endpoint device prior to step 410 in FIG. 4A. Additionally or alternatively, the initialization operation may be performed after step 411 in FIG. 4B. In at least some examples, an aggregator device may need to perform (at least part of) the initialization for each endpoint device. New endpoint devices may be dynamically added at any time (e.g., at a future time), such that not all initialization may happen at the same time. The initialization operation may comprise a controller (e.g., controller 302 described with respect to FIG. 3) communicating with a DSP (e.g., DSP 301 described with respect to FIG. 3) to request and/or receive information such as a version (e.g., DNI version) and/or supported feature(s) of the DSP. The controller may query an interface version (e.g., DNI interface version). Querying an interface version may comprise sending a request message. The request message may request information such as a parameter type, identifier/ID, and/or interface version. A DSP may receive the request. Based on receiving the request, the DSP may determine (e.g., by looking up in memory) an interface version. The DSP may send a response to the controller. The controller may receive the response, which may include a parameter type report, an identifier/ID, and/or an interface version. The controller may query one or more supported features (e.g., after querying the interface version). For example, the controller may send a request for one or more supported features, the DSP may determine (e.g., by looking up in memory) the supported feature(s), and the DSP may send (and the controller may receive) a response comprising an indication of the supported feature(s). The controller and/or the DSP may repeat the request, determine/look-up, and response process for each feature that may be supported (e.g., in a loop). Additionally or alternatively, the controller and/or the DSP may perform the request, determine/look-up, and response process for all features that may be supported together (e.g., in parallel and/or in the same messaging for all features). The controller and/or the DSP may discontinue the request, determine/look-up, and response process for the supported feature(s), for example, based on a determination that all supported features have been identified and/or that all features have been evaluated for whether they are supported.

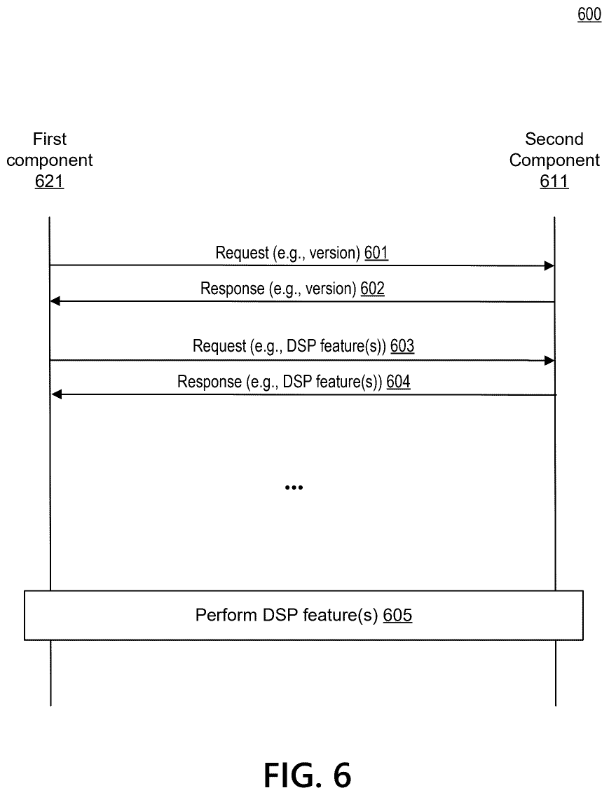

The initialization process may include the controller storing information received from the DSP, which may enable other devices to enquire about supported features for a host device. In at least some examples, as a default, the controller may be booted up with all features disabled and no sessions to other devices. In such examples, an aggregator device may maintain/persist a feature, for example, if a feature must be maintained/persisted. The aggregator may reestablish with one or more endpoints connection(s) and/or setting(s) for a feature. To be able to configure a device (e.g., device 300) correctly and/or to be able to determine if/whether a device is suitable for a feature to be enabled, an aggregator may be required to request a version, capability, and/or feature versions of the device. To do so, a controller of an aggregator device (e.g., 121, 221) may communicate with a controller of an endpoint device (e.g., 111-113, 211-215), whereby the aggregator controller may send a request for version information, the endpoint controller may send a response indicating version information, the aggregator controller may send a request for supported features, and the endpoint controller may send a response indicating supported features (e.g., such as described in further detail with respect to FIG. 6). If, however, the aggregator controller does not receive a response to these requests from the endpoint controller, the aggregator controller may (optionally) instruct its session manager (e.g., session manager 332) to communicate with a session manager of an endpoint device, for example, to determine whether the endpoint device supports any networked feature at all. In at least some examples, the aggregator controller may not instruct its session manager (e.g., session manager 332) to communicate with a session manager of an endpoint device. For example, an aggregator device may determine that a particular endpoint device may not (or does not) support networked DSP features (e.g., without communicating with a session manager). The aggregator session manager may send a request, to the endpoint session manager, for identification of capabilities of the endpoint device. The endpoint session manager may then send, to the aggregator session manager, an indication of one or more capabilities and/or channels (e.g., visible and/or hidden TX and/or RX channels) of the endpoint device. If the aggregator session manager does not receive a response indicating one or more capabilities of the endpoint device, the aggregator device may determine that the particular endpoint device does not support networked DSP features.

During the initialization process, each feature controller may register itself with the controller (e.g., controller 302). Registration may comprise a feature controller sending indications of a feature ID, an associated feature capability, and/or a priority associated with the feature. The controller may store the received indications in memory for later reference. For example, the controller may rely upon this information to manage interoperability between different features on the same device (e.g., for feature arbitration, priority, etc.), for feature advertisement to the rest of an audio system (e.g., 100, 200), and/or to manage interoperability between different devices in an audio system. Feature matrices may be used to indicate feature concurrency, interoperability, arbitration, and/or priority. For example, at least some features may be incompatible with other features such that they may not be enabled at the same time for a particular device. As another example, at least some features may have higher priority than other features, such that resources should be allocated to the higher priority features prior to allocating resources for lower priority features. As still another example, at least some features may have concurrency and/or priority specific to use in a device when used as an aggregator device and that may differ from concurrency and/or priority specific to use in the device when used as an endpoint device. Any one or more of concurrency, capabilities, and/or priorities, for any one or more devices (e.g., endpoint devices and/or aggregator devices) may be stored in memory, such as in a table, matrix, and/or data set.

At step 520, the device may perform a feature enable and/or disable operation. An enable operation may comprise identifying one or more endpoint devices (e.g., 111-113, 211-215) to be used for a feature and enabling at least one aggregator device (e.g., 121, 221) and the identified endpoint device(s), so as to be able to perform networked DSP. A controller (e.g., controller 302) may enable or disable a particular networked DSP feature. The controller may inform a DSP (e.g., DSP 301) of its role for the networked DSP feature. For example, the controller may send a request to the DSP that indicates one or more of: a parameter type set, a device ID, a feature ID, and/or a feature enablement request. The DSP may validate the request. For example, the DSP may determine and/or indicate, for example, that the feature is not supported, that a role is not supported, that an aggregation link position is invalid, that request cannot be performed (e.g., that a request to disable a feature that is active, and/or that a request to enable a feature that is already enabled). After receiving a response from the DSP indicating that a feature has been enabled, the controller may create a channel link. The controller may indicate the channel link to the DSP.

At step 530, the device may perform aggregation link setup. A controller (e.g., controller 302) may request that a DSP (e.g., DSP 301) set up an aggregation link at a particular aggregation link position. An aggregation link may provide a real-time data link for communication of data in an audio system. An aggregation link may comprise a combination of routes (e.g., visible and/or invisible routes) that may be required to enable one or more networked DSP features. Aggregation links may be managed by an aggregator device (e.g., 121, 221). An aggregation link may be used to exchange time-critical data. Data communicated via an aggregation link may comprise audio and/or other data to be communicated via low latency from a device to one or more other devices. An aggregation link may use one or more protocols (e.g., Dante, AES67, RTP, etc.) for real-time DSP. For example, after one or more DSP features are enabled (e.g., at step 520), an aggregation link may be set up to allow for low-latency communications that may facilitate the control and/or operation of networked DSP. An aggregation link may be unidirectional or bidirectional. Aggregation link setup may comprise setting up a plurality of aggregation links. In at least some examples, one or more other links may be established that may be used to communicate non-time-critical information, such as via a non-time-critical protocol (e.g., ACN).

An aggregation link position may correspond to an index of a particular aggregation link (e.g., 0 to N-1, where N is the maximum number of endpoint devices supported by the aggregator). A DSP may have stored in memory feature-specific information as to what channels are required for a particular feature. Before setup, a feature must be enabled with at least one device (e.g., 300) having a role as an aggregator device (e.g., 121, 221). For example, an endpoint (e.g., 111-113, 211-215) may not be configured to set up an aggregation link. To set up an aggregation link, the controller may send a request to the DSP. The DSP may validate the request, for example, based on stored information about device(s). The DSP may send a response to the controller indicating, for example, whether a role as an aggregator device is supported for a particular device, and/or whether a channel is available. The controller and the DSP may communicate session management requests/responses for each channel (e.g., in parallel or in sequence). After all sessions have been created, the aggregation link may be established.

At step 540, the device may perform aggregation link teardown. Step 540 may be optional, for example, to update the links between devices of an audio system by removing links that are no longer needed (e.g., based on device turnoff/power down, device experiencing failure(s), feature deactivation for a device using a link, limitations reached or exceeded for a device, etc.). A controller (e.g., controller 302) may request that a DSP (e.g., DSP 301) teardown an aggregation link. Before teardown, a feature must be enabled with at least one device (e.g., 300) having a role as an aggregator device (e.g., 121, 221). For example, an endpoint (e.g., 111-113, 211-215) may not be configured to teardown an aggregation link. To teardown an aggregation link, the controller may send a request to the DSP. The DSP may validate the request, for example, based on stored information about device(s). The DSP may send a response to the controller indicating, for example, whether the aggregation link is found, and/or whether all sessions may be closed. The controller and the DSP may communicate session management requests/responses for each channel (e.g., in parallel or in sequence). After all sessions have been closed, the aggregation link may be torn down.

At step 550, the device may perform feature activation and/or deactivation. A feature may have a mode that is either active or inactive. A feature may be required to be enabled before it can be activated. Similarly, a feature may be required to be deactivated before it can be disabled. A controller (e.g., controller 302) may request that a DSP (e.g., DSP 301) activate or deactivate a feature. The DSP may validate the request, for example, based on stored information about device(s). The DSP may send a response to the controller indicating, for example, whether a feature is supported, whether an aggregation link position is valid, and whether a mode is invalid (e.g., if a request is to activate a feature that is not enabled, or if a request is to deactivate a feature that is inactive). After the DSP sends a response, the controller may perform the requested operation for the feature (e.g., activate the feature or deactivate the feature).

When configuring a networked feature, each device (e.g., device 300) may be identified by a device ID. The device ID may be determined by a controller (e.g., controller 302) and provided to a DSP (e.g., DSP 301). The DSP may use the feature to configure communications by a session manager (e.g., session manager 332) and to identify the device when communicating with the controller. Additionally or alternatively, a device may be identified by a link position (e.g., starting from 0). For example, a device ID may be a certain number or value, but when configuring a feature each device may also be identified by its link position. The link position may be used by the DSP to address other DSP over assigned channels. If a feature is enabled and/or activated, a controller may look up in a device list to identify a candidate device that is qualified for the feature. After a feature has been enabled in all qualified and enabled devices, the feature may be activated in each of those devices.

Any step, or portion of step, shown in FIG. 5 and/or described herein may be optional and/or may be performed in any order. For example, step 510 (e.g., initialization) may be performed, followed by a portion of step 520 (e.g., feature enablement), followed by step 530 (e.g., aggregation link setup), and followed by a portion of step 550 (e.g., feature activation). That is, feature disablement (e.g., a portion of step 520), aggregation link teardown (e.g., step 540), and/or feature deactivation (e.g., a portion of step 550) may not be performed and/or may be performed at a later time and/or out of sequence relative to other steps shown and described with respect to FIG. 5. After feature activation (e.g., a portion of step 550), the activated DSP feature may be performed. After feature deactivation (e.g., another portion of step 550), the deactivated DSP feature may not be performed, for example, at least until it may be re-enabled (e.g., such as by a portion of step 520 being performed) and/or re-activated (e.g., such as by a portion of step 550 being performed). In at least some examples, one or more steps of FIG. 5 may be performed for one DSP feature at a time (e.g., in series). In at least some other examples, one or more steps of FIG. 5 may be performed for a plurality of DSP features at a same time (e.g., in parallel).

FIG. 6 shows an example method for configuring networked DSP features. A method 600 may comprise a first component 621 communicating with one or more second components 611. The first component 621 and/or the second component 611 may be audio components. For example, the first component 621 and/or the second component 611 may comprise and/or may be included within one or more components of a device, such as of a device 300 described with respect to FIG. 3. For example, the first component 621 may comprise and/or may be included within the DSP 301. The second component 611 may comprise and/or may be included within the controller 302. As another example, the first component 621 and the second component 611 may comprise and/or be included within different devices, such as each component being one of two of device 300. For example, the first component 621 may comprise and/or may be included within an aggregator device (e.g., 121, 221). The aggregator device may correspond a first example of the device 300. The second component 611 may comprise and/or may be included within an endpoint device (e.g., 111-113, 211-215). The endpoint device may correspond to a second example of the device 300. The method 600 may comprise one or more operations of the methods 400, 401, and/or 500 described with respect to FIG. 4A, FIG. 4B, and/or FIG. 5, respectively.

Communications between the first component 621 and the second component 611 may comprise one or more requests and one or more corresponding responses. For example, the first component 621 may send to the second component 611 a request 601 that indicates information such as an ID, version, and/or capability of the first component 621 and/or that requests information such as an ID, version, and/or capability of the second component 611. The second component 611 may send to the first component 621 a response 602 that indicates an acknowledgement and/or information such as the ID, version, and/or capability of the second component 611. Based on the request 601 and/or the response 602, the first component 621 and/or the second component 611 may be initialized and/or configured to perform networked DSP generally in an audio system (e.g., 100, 200), although specific DSP features may not yet be enabled and/or activated by steps 601 and 602.

The first component 621 may send to the second component 611 a request 603. The request 603 may be sent, for example, after steps 601 and 602. The request 603 may indicate information such as DSP feature capability of the first component 621 and/or may request information such as DSP feature capability of the second component 611. The second component 611 may send to the first component 621 a response 604 that indicates an acknowledgement and/or information such as the DSP feature capability of the second component 611. Based on the request 603 and/or the response 604, the first component 621 and/or the second component 611 may be initialized and/or configured to perform specific DSP features (e.g., based on the DSP feature capability of the respective device(s)). As an example, specific DSP features may be enabled and/or activated in a manner as described with respect to step 520 and/or step 550 of FIG. 5. At step 605, the first component 621 and/or the component device 611 may perform one or more DSP features (e.g., based on the DSP feature capability of the respective device(s)).

One or more additional operations may be performed after steps 601-604 and before step 605. For example, steps 601-604 may be included in an initialization process, such as step 510 described with respect to FIG. 5, and any operation described with respect to steps 520, 530, 540, and/or 550 described with respect to FIG. 5 may be performed before step 605.

In at least some examples, the first component 621 may comprise an endpoint device (e.g., 111-113, 211-215), and the second component 611 may comprise an aggregator device (e.g., 121, 221). As another example, the first component may 621 comprise an aggregator device (e.g., 121, 221), and one or more second components 611 may comprise one or more endpoint devices (e.g., 111-113, 211-215). In such an example, the request 601 and/or the request 603 may comprise a message (e.g., advertisement message) sent to a plurality of endpoint devices. Also, in such an example, the response 602 and/or the response 604 may comprise a plurality of messages, wherein each message may be sent by a different endpoint device among a plurality of endpoint devices. As yet another example, the first component 621 may comprise the device 300 described with respect to FIG. 3, and the second component 611 may comprise another device 300. As still another example, the first component 621 may comprise one or more portions of the device 300 (such as DSP 301 and/or controller 302), and the second component 621 may comprise one or more other portions of the same device 300 (such as controller 302 and/or DSP 301).

A first audio component may perform one or more operations. For example, the first audio component may send, to a second audio component, a request for digital signal processing (DSP) feature capability of the second audio component. The first audio component may receive (e.g., from the second audio component) a response indicating DSP feature capability of the second audio component. The first audio component may determine, based on the DSP feature capability of the second audio component and based on a DSP feature capability of the first audio component, one or more DSP features to perform. The first audio component may perform the one or more DSP features. The first audio component may perform the one or more DSP features by: receiving, from an audio component that is configured to perform a first portion of DSP associated with an audio signal, an output of the first portion of DSP; and/or performing, based on the output of the first portion of DSP, a second portion of DSP associated with the audio signal. The first portion of DSP may be associated with detection of the audio signal. The first portion of DSP may comprise at least one of: detection of the audio signal; detection of a location of the audio signal; noise reduction associated with the audio signal; acoustic echo cancellation associated with the audio signal; automatic gain control; and/or statistics derived from time-averaged audio signal level in specific frequency band (e.g., time-averaged audio signal level in one or more specific frequency bands). The second portion of DSP may be associated with an audio DSP procedure for the audio signal. Performing the second portion of DSP may comprise at least one of: mixing associated with the audio signal; filtering associated with the audio signal; and/or equalization associated with the audio signal; noise reduction associated with the audio signal; acoustic echo cancellation associated with the audio signal; and/or automatic gain control. The audio component that is configured to perform the second portion of DSP may be the second audio component. The first audio component may be a digital signal processor of an audio device. The second audio component may be a controller of the audio device. The audio device may be (or may be included in) one of: an aggregator device; or an endpoint device. The first audio component may be (or may be included in) an aggregator device configured to communicate with a plurality of endpoint devices that are each configured to perform at least a portion of DSP of the one or more DSP features. The second audio component may be (or may be included in) an endpoint device, of the plurality of endpoint devices, that is configured to perform a first portion of DSP of the one or more DSP features. The first audio component may receive at least one parameter from each of a plurality of endpoint devices. Determination of the one or more DSP features to perform may be further based on the at least one parameter from each of the plurality of endpoint devices. The first audio component may send, to one or more endpoint device of a plurality of endpoint devices, one or more indications of one or more DSP features to be performed by the respective one or more endpoint device. A computing device may comprise the first audio component. The computing device may comprise: one or more processors; and memory storing instructions that, when executed, cause the computing device to perform one or more of the above operations. A system may comprise the first audio component and the second audio component (or a plurality of second audio components). The system may comprise an aggregator device comprising the first audio component; and one or more endpoint devices comprising the second audio component (e.g., a plurality of endpoint devices, each of which comprise a second audio component). A non-transitory computer-readable medium may store instructions that, when executed, cause performance of one or more of the above operations.

Various examples herein describe an aggregator device (e.g., 121, 221) that may be used to flexibly control and/or communicate with one or more endpoint devices (e.g., 111-113, 211-215). Endpoint devices may be any audio devices which may comprise wired and/or wireless speakers, headphones, microphones, audio signal transceivers, and/or any other type of audio input and/or output device. The aggregator device may comprise one or more radio interfaces corresponding to any proprietary and/or non-proprietary wireless communication protocol. For example, the one or more radio interfaces may conform to Bluetooth protocol, Bluetooth protocol(s), Institution of Electrical and Electronics Engineers (IEEE) 802.11 Wi-Fi protocol(s), and/or any other wireless communication protocol. The aggregator device may additionally comprise one or more wired interfaces for communication with wired audio devices. The one or more wired interfaces may comprise one or more Ethernet interfaces, XLR interface(s), universal serial bus (USB) interface(s), 3.5 mm audio interface(s), and/or any other proprietary and/or non-proprietary wired interface(s).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method comprising:
sending, by a first audio component to a second audio component, a request for digital signal processing (DSP) feature capability of the second audio component;
receiving, by the first audio component, a response indicating DSP feature capability of the second audio component;
determining, based on the DSP feature capability of the second audio component and based on a DSP feature capability of the first audio component, one or more DSP features to perform; and
performing the one or more DSP features.

2. The method of claim 1, wherein the performing the one or more DSP features comprises:
receiving, from an audio component that is configured to perform a first portion of DSP associated with an audio signal, an output of the first portion of DSP; and
performing, based on the output of the first portion of DSP, a second portion of DSP associated with the audio signal.

3. The method of claim 2, wherein:
the first portion of DSP is associated with detection of the audio signal; and
the second portion of DSP is associated with an audio DSP procedure for the audio signal.

4. The method of claim 2, wherein the audio component that is configured to perform the second portion of DSP is the second audio component.

5. The method of claim 1, wherein the first audio component is a digital signal processor of an audio device, and wherein the second audio component is a controller of the audio device.

6. The method of claim 5, wherein the audio device is one of: an aggregator device; or an endpoint device.

7. The method of claim 1, wherein:
the first audio component is an aggregator device configured to communicate with a plurality of endpoint devices that are each configured to perform at least a portion of DSP of the one or more DSP features; and
the second audio component is an endpoint device, of the plurality of endpoint devices, that is configured to perform a first portion of DSP of the one or more DSP features.

8. A first audio component comprising:
one or more processors; and
memory storing instructions that, when executed by the one or more processors, cause the first audio component to:
send, to a second audio component, a request for digital signal processing (DSP) feature capability of the second audio component;
receive a response indicating DSP feature capability of the second audio component;
determine, based on the DSP feature capability of the second audio component and based on a DSP feature capability of the first audio component, one or more DSP features to perform; and
perform the one or more DSP features.

9. The first audio component of claim 8, wherein the instructions, when executed, cause the first audio component to perform the one or more DSP features by:
receiving, from an audio component that is configured to perform a first portion of DSP associated with an audio signal, an output of the first portion of DSP; and
performing, based on the output of the first portion of DSP, a second portion of DSP associated with the audio signal.

10. The first audio component of claim 9, wherein:
the first portion of DSP is associated with detection of the audio signal; and
the second portion of DSP is associated with an audio DSP procedure for the audio signal.

11. The first audio component of claim 9, wherein the audio component that is configured to perform the second portion of DSP is the second audio component.

12. The first audio component of claim 8, wherein the first audio component is a digital signal processor of an audio device, and wherein the second audio component is a controller of the audio device.

13. The first audio component of claim 12, wherein the audio device is one of: an aggregator device; or an endpoint device.

14. The first audio component of claim 8, wherein:
the first audio component is an aggregator device configured to communicate with a plurality of endpoint devices that are each configured to perform at least a portion of DSP of the one or more DSP features; and
the second audio component is an endpoint device, of the plurality of endpoint devices, that is configured to perform a first portion of DSP of the one or more DSP features.

15. A non-transitory computer-readable medium storing instructions that, when executed, cause performance of:
sending, by a first audio component to a second audio component, a request for digital signal processing (DSP) feature capability of the second audio component;
receiving, by the first audio component, a response indicating DSP feature capability of the second audio component;
determining, based on the DSP feature capability of the second audio component and based on a DSP feature capability of the first audio component, one or more DSP features to perform; and
performing the one or more DSP features.

16. The non-transitory computer-readable medium of claim 15, wherein the performing the one or more DSP features comprises:
receiving, from an audio component that is configured to perform a first portion of DSP associated with an audio signal, an output of the first portion of DSP; and
performing, based on the output of the first portion of DSP, a second portion of DSP associated with the audio signal.

17. The non-transitory computer-readable medium of claim 16, wherein:
the first portion of DSP is associated with detection of the audio signal; and
the second portion of DSP is associated with an audio DSP procedure for the audio signal.

18. The non-transitory computer-readable medium of claim 15, wherein the first audio component is a digital signal processor of an audio device, and wherein the second audio component is a controller of the audio device.

19. The non-transitory computer-readable medium of claim 18, wherein the audio device is one of: an aggregator device; or an endpoint device.

20. The non-transitory computer-readable medium of claim 15, wherein:
the first audio component is an aggregator device configured to communicate with a plurality of endpoint devices that are each configured to perform at least a portion of DSP of the one or more DSP features; and
the second audio component is an endpoint device, of the plurality of endpoint devices, that is configured to perform a first portion of DSP of the one or more DSP features.
